(19) United States
(12) Patent Application Publication
(10) Pub. No.: US 2026/0126015 A1
(43) Pub. Date: May 7, 2026

(54) INTERCHANGING DRIVE TRAIN SYSTEM

(71) Applicant: Solar Turbines Incorporated, San Diego, CA (US)

(72) Inventors: Richard A. TAM, San Diego, CA (US); Miguel ANGEL, Escondido, CA (US)

(73) Assignee: Solar Turbines Incorporated, San Diego, CA (US)

(21) Appl. No.: 18/919,798

(22) Filed: Oct. 18, 2024

(51) Int. Cl. F02C 7/36

(52) U.S. Cl. CPC F02C 7/36; F05D 2220/74; F05D 2260/98; F05D 2270/06

(57) ABSTRACT

In one instance, disclosed herein is an interchanging drive train system for driving a compressor comprising: an interchanging gearbox coupled to the compressor; a gas turbine selectively coupled to the interchanging gearbox via a first coupling mechanism; and an electric motor selectively coupled to the interchanging gearbox via a second coupling mechanism, wherein the interchanging gearbox is configured to allow the compressor to be interchangeably driven by the gas turbine and the electric motor.

### TECHNICAL FIELD

The present disclosure relates generally to drive trains for gas compressors, and more particularly, to methods and systems for driving a gas compressor with interchangeable drivers.

### BACKGROUND

Natural gas accounts for approximately 30% of the energy used in the United States. Natural gas in its gaseous form is used in residential and commercial environments for heating, cooking, and to generate electricity, to name only a few applications. To be used as a fuel for vehicles, however, natural gas is typically compressed and/or cooled into compressed natural gas (CNG) or liquefied natural gas (LNG). CNG may possess a volume that is approximately 1% of the volume of natural gas at standard atmospheric temperature and pressure; LNG may possess a volume that is approximately 1/600^{th} of the volume of natural gas at the same conditions. The reduced volume of CNG and LNG may allow these fuels to be transported or used more easily, more safely, and/or more economically than natural gas in its gaseous form.

Gas compressors may be used to produce CNG and/or LNG from gaseous natural gas. For example, a gas compressor may be used to compress gaseous natural gas into CNG. Or for example, gaseous natural gas may be fed from a pipeline into a gas compressor to raise the pressure of the natural gas to a level sufficient for further processing, or to compress refrigerants necessary to cool the gaseous natural gas. Gas compressors are typically driven by a drive train including a gas turbine engine. However, as emissions regulations become more stringent, operators of gas compressors are becoming increasingly interested in drive trains capable of utilizing flexible fuels and alternative operating methods.

A hybrid dual-power drive system is disclosed in U.S. Pat. No. RE48,752 (the '752 patent). The hybrid dual-power drive system described in the '752 patent includes an engine and one or more dynamo-electric units. In a serial transmission mode, the engine may drive a load using rotational kinetic energy, or the engine and the one or more dynamo-electric units may drive the load using rotational kinetic energy. In a parallel power transmission mode, the engine may drive a load using rotational kinetic energy, and the one or more dynamo-electric units may drive a different electrically-powered load using electricity generated by the one or more dynamo-electric units. The '752 patent addresses systems for driving a multi-load system, rather than, for example, a single load system.

The methods and systems of the present disclosure may solve one or more of the problems set forth above and/or other problems in the art. The scope of the protection provided by the present disclosure, however, is defined by the attached claims, and not by the ability to solve any specific problem.

### SUMMARY

In one aspect, an interchanging drive train system for driving a compressor includes: an interchanging gearbox coupled to the compressor; a gas turbine engine selectively coupled to the interchanging gearbox via a first coupling mechanism; and an electric motor selectively coupled to the interchanging gearbox via a second coupling mechanism, wherein the interchanging gearbox is configured to allow the compressor to be interchangeably driven by the gas turbine engine and the electric motor.

In another aspect, a controller for an interchanging drive train system comprising a gas turbine engine, an electric motor, and an interchanging gearbox coupled to a compressor, selectively coupled to the gas turbine engine, selectively coupled to the electric motor and configured to allow the compressor to be interchangeably driven by the gas turbine engine and the electric motor includes a processor configured to: receive an output speed of the gas turbine engine and an output speed of the electric motor from at least one driver output sensor coupled to the gas turbine engine and the electric motor; and manage one or more aspects of an interchange of the gas turbine engine and the electric motor based at least in part on the output speed of the gas turbine engine and the output speed of the electric motor.

In another aspect, an interchanging drive train system for driving a compressor includes: a gas turbine engine; an electric motor; an interchanging gearbox selectively coupled to the gas turbine engine via a first coupling mechanism, selectively coupled to the electric motor via a second coupling mechanism, coupled to the compressor, and configured to allow the compressor to be interchangeably driven by the gas turbine engine and the electric motor; and a controller configured to manage one or more aspects of an interchange of the gas turbine engine and the electric motor, wherein the compressor is coupled to a first side of the interchanging gearbox, and wherein the gas turbine engine and the electric motor are arranged in parallel and coupled to a second side of the interchanging gearbox opposite the first side.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a schematic diagram of an exemplary interchanging drive train system;

FIG. 2 depicts a block diagram of an exemplary controller; and

FIG. 3 depicts a flowchart of an exemplary method for controlling an interchanging drive train system.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “substantially,” “generally,” and “approximately” are used to indicate a possible variation of ±10% in the stated value. In this disclosure, the term “based on,” or any other variation thereof, is intended to cover, for example, “partially based on,” “at least partially based on,” and “based entirely on. ” As used herein, “coupled” is understood to mean two or more elements, features, devices, systems, components, etc. which can be attached, engaged, paired, and/or connected to each other communicatively (wirelessly or wired or a combination thereof), operatively, mechanically, magnetically, electrically, chemically, fluidly, or combinations thereof.

As used herein, “removably coupled” is understood to mean two or more elements, devices, features, systems, components, etc. which can be coupled to each other and then uncoupled without harming the previously coupled components, such that removably coupled elements can be coupled and recoupled a predetermined number of times without negatively impacting the functionality of the elements, devices, features, systems, and/or components individually or of the coupled configuration.

As used herein, “permanently coupled” is understood to mean two or more elements, devices, systems, features, components, etc. which can be coupled to each other and then uncoupled, such that permanently coupled elements cannot be uncoupled and recoupled without damaging and/or having to refurbish or repair at least one element, device, feature, system, and/or component.

As used herein, “selectively coupled” is understood to mean two elements, devices, systems, features, components, etc. which can be coupled to each other and then uncoupled without rendering inoperable a system or an apparatus including the two elements, devices, systems, features, components, etc., such that the system or the apparatus may be operable in a first configuration in which the the two elements, devices, systems, features, components, etc. are coupled and a second configuration in which the two elements, devices, systems, features, components, etc. are uncoupled.

It should also be understood that the various components illustrated herein are not necessarily drawn to scale. In other words, the features disclosed in various embodiments may be implemented using different relative dimensions within and between components than those illustrated in the drawings.

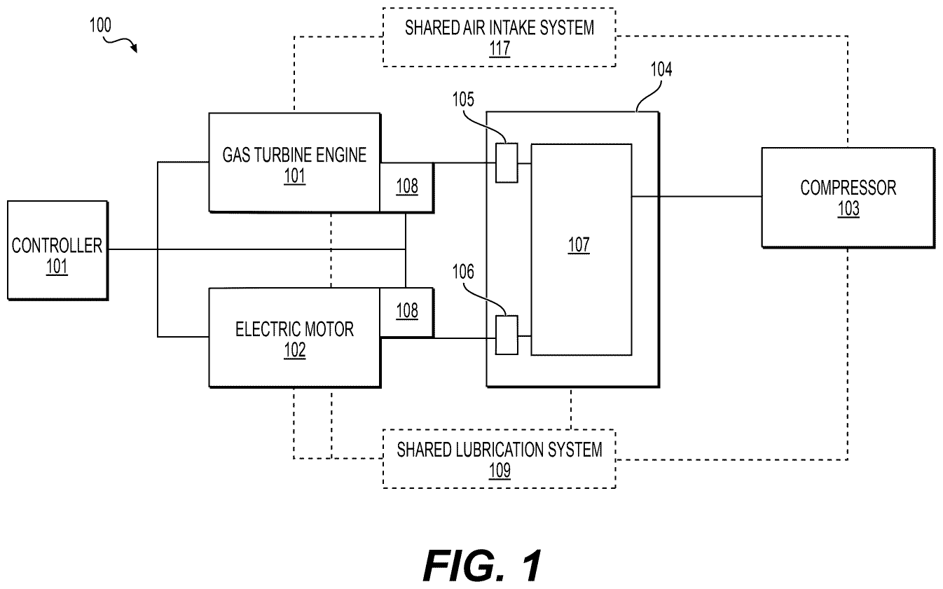

FIG. 1 depicts a schematic diagram of an exemplary interchanging drive train system 100. As shown in FIG. 1, the interchanging drive train system 100 may include at least two different drivers, such as a first driver including a gas turbine engine 101 and a second driver including an electric motor 102, capable of interchangeably driving a load, such as a compressor 103. The gas turbine engine 101 may be configured to output mechanical or kinetic energy, e.g., torque, by combusting a fuel. The gas turbine engine 101 may include any suitable type of gas turbine engine, such as a single-shaft gas turbine engine or a multi-shaft gas turbine engine, and may include any components consistent with any function of a gas turbine engine, such as a compressor, a combustor, a turbine, and an output shaft. The electric motor 102 may be configured to convert electrical energy into mechanical or kinetic energy, e.g., torque. The electric motor 102 may include any suitable type of electric motor, such as a variable-frequency drive (VFD) or a variable-speed drive (VSD). Both the gas turbine engine 101 and the electric motor 102 may include or otherwise be coupled to a driver output sensor 108 (e.g., a torque sensor or a shaft speed sensor) capable of detecting, measuring, and/or outputting an output (e.g., an output speed or torque) of the driver in which it is included. While the interchanging drive train system 100 is often described herein as including a gas turbine engine 101 and an electric motor 102, it will be understood that the drivers of the interchanging drive train system 100 may include any type of mechanism or device capable of producing mechanical or kinetic energy. For example, in some instances, the interchanging drive train system 100 may include a gas turbine engine and a steam turbine engine.

As shown in FIG. 1, the gas turbine engine 101 and the electric motor 102 may be arranged in parallel. The gas turbine engine 101 and the electric motor 102 being arranged in parallel, as opposed to being arranged in series, may reduce a footprint (e.g., a total length) of the interchanging drive train system 100, facilitate the application of one or more shared operational systems (as described in further detail below), and/or facilitate an interchange between the gas turbine engine 101 and the electric motor 102 by an interchanging gearbox 104 (as described in further detail below). In some instances, the gas turbine engine 101 and the electric motor 102 may be housed within separate enclosures. Housing the gas turbine engine 101 and the electric motor 102 within separate enclosures may prevent or reduce unwanted heat transfer between the gas turbine engine 101 and the electric motor 102.

The gas turbine engine 101 and the electric motor 102 may be coupled to a compressor 103, e.g., a gas compressor, by an interchanging gearbox 104 that is coupled to the compressor 103. While the interchanging drive train system 100 is often described herein as including a compressor 103, it will be understood that the interchanging drive train system 100 may include any mechanism or device capable of being driven by mechanical or kinetic energy, such as a generator.

The gas turbine engine 101 may be selectively coupled to the gearbox 104, and, by extension, to the compressor 103, by a first coupling mechanism 105 housed within the interchanging gearbox 104. The first coupling mechanism 105 may be selectively coupled to the gas turbine engine 101 by an output shaft included in the gas turbine engine 101. The electric motor 102 may be selectively coupled to the interchanging gearbox 104, and, by extension, to the compressor 103, by a second coupling mechanism 106 housed within the interchanging gearbox 104. The second coupling mechanism 106 may be selectively coupled to the electric motor 102 by an output shaft included in the electric motor 102. The first coupling mechanism 105 and the second coupling mechanism 106 may include any suitable type of coupling mechanism, such as an overrunning or freewheel clutch device. The first coupling mechanism 105 and the second coupling mechanism 106 may be mechanically operated and coupled to one another via a set of gears 107 within the interchanging gearbox 104, such that the engagement of the first coupling mechanism 105 may cause the second coupling mechanism 106 to disengage, and vice versa, thereby facilitating interchange between the gas turbine engine 101 and the electric motor 102, as described in further detail below.

The interchanging gearbox 104 may be coupled to the compressor 103 via an output shaft included in the interchanging gearbox 104, and the first coupling mechanism 105 and the second coupling mechanism 106 may be coupled to the output shaft included in the interchanging gearbox 104 by the set of gears 107 within the interchanging gearbox 104. The set of gears 107 within the interchanging gearbox 104 may include one or more gear ratios, and the one or more gear ratios may be determined at least in part by the respective outputs, e.g., output speeds or output torques, of the gas turbine engine 101 and the electric motor 102. The parallel arrangement of the gas turbine engine 101 and the electric motor 102 may allow for the simplest of arrangements of the set of gears 107 to facilitate interchange between the gas turbine engine 101 and the electric motor 102, such as by positioning an output shaft of the gas turbine engine 101 and an output shaft of the electric motor 102 in to be in parallel and to engage the first coupling mechanism 105 and the second coupling mechanism 106 on the same side of the interchanging gearbox 104. The compressor 103 may be positioned on a side of the interchanging gearbox 104 opposite that of the gas turbine engine 101 and the electric motor 102.

As mentioned above, the interchanging drive train system 100 may also include one or more shared operational systems, such as a shared lubrication system 109 or a shared air intake system 117. A shared operational system may include a unified system capable of providing the same, or similar, function(s) to multiple components of the interchanging drive train system 100. For example, a shared lubrication system 109 may be a unified system including a single lube pump capable of providing lube oil to two or more of the gas turbine engine 101, the electric motor 102, the interchanging gearbox 104, and the compressor 103 to minimize wear, friction and excess heat generation. Or, for example, a shared air intake system 117 may be a unified system including a single air filter capable of providing filtered intake air to both the gas turbine engine 101 and the compressor 103. The parallel arrangement of the gas turbine engine 101 and the electric motor 102 may facilitate the application of the one or more shared operational systems, such as by reducing the space between the gas turbine engine 101, the electric motor 102, the interchanging gearbox 104, and/or the compressor 103 enough to make the application of the one or more shared operational systems more physically, technically, and/or economically viable.

The interchanging drive train system 100 may also include a controller 110, e.g., an electronic control module (ECM), capable of controlling one or more components or functions of the interchanging drive train system 100, such as the gas turbine engine 101 and the electric motor 102. For example, as described in further detail below, the controller 110 may be operative facilitate or manage one or more aspects of an interchange between the gas turbine engine 101 and the electric motor 102.

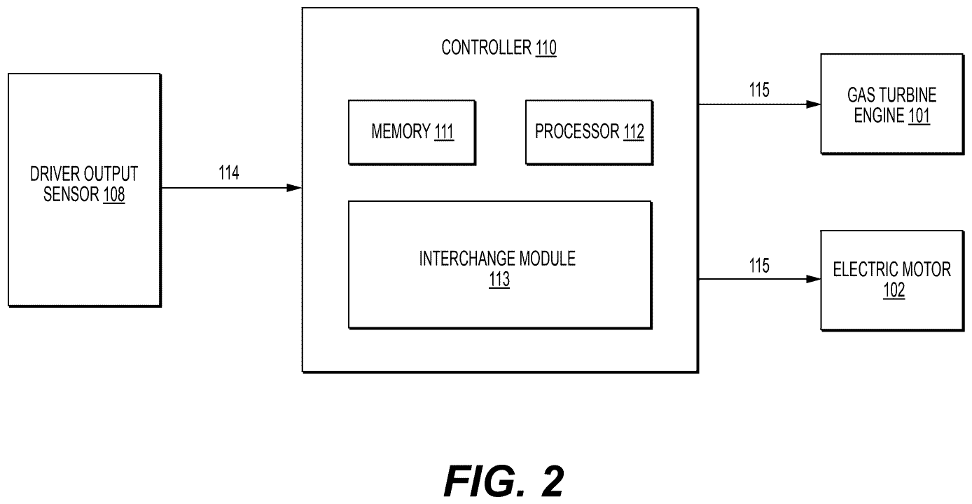

FIG. 2 depicts a block diagram of an exemplary controller 110, e.g., an ECM. The controller 110 may include a memory 111, a processor 112, or any other means for accomplishing a task consistent with the present disclosure. The memory 111 may store data and/or software configured to enable the processor 112 to perform various functions. In particular, the memory 111 and/or the processor 112 may allow the controller 110 to perform any of the interchanging functions described herein. Numerous commercially available microprocessors can be configured to perform the functions of the controller 110. Various other known circuits may be associated with the controller 110, including signal-conditioning circuitry, communication circuitry, and/or any other appropriate type of circuitry. As used herein, “controller” encompasses a single controller or multiple controllers operatively or communicatively coupled to one another and/or other components of the interchanging drive train system 100.

The controller 110 may include one or more modules configured to receive sensed inputs and generate commands and/or other signals to control the operation of the interchanging drive train system 100. For example, controller 110 may include an interchange module 113 (e.g., instructions stored in the memory 111) configured to receive driver output sensor data 114 (e.g., output speed or torque data) from one or more driver output sensors 108 (e.g., one or more shaft speed sensors or torque sensors) and generate, based on the driver output sensor data 114, driver control commands 115 that may be transmitted to the gas turbine engine 101 and/or the electric motor 102, e.g., to facilitate or manage an interchange between the gas turbine engine 101 and the electric motor 102.

### INDUSTRIAL APPLICABILITY

The systems, apparatuses, and methods disclosed herein may find application in any drive train system. In particular, the systems, apparatuses, and methods disclosed herein may be advantageously used in any drive train system for which it is desirable to drive a load using different drivers.

As mentioned above, and as described in further detail below, the interchanging drive train system 100 is capable of allowing a compressor 103 to be interchangeably driven by a gas turbine engine 101 and an electric motor 102. In doing so, the interchanging drive train system 100 allows the compressor 103 to be flexibly operated by different fuels and power sources. For simplicity, in the examples described hereinafter, the interchanging drive train system 100 includes a gas turbine engine 101, an electric motor 102, and a compressor 103. However, as mentioned above, it will be understood that the drivers of the interchanging drive train system 100 may include any type of mechanism or device capable of producing mechanical or kinetic energy, and the load of the interchanging drive train system 100 may include any mechanism or device capable of being driven or powered by mechanical or kinetic energy.

In some instances, outside of an interchange between the gas turbine engine 101 and the electric motor 102, only one of the gas turbine engine 101 and the electric motor 102 may be used by the interchanging drive train system 100 to drive the compressor 103. For example, in such an instance, outside of an interchange between gas turbine engine 101 and the electric motor 102, the gas turbine engine 101 may be coupled to the interchanging gearbox 104 via the first coupling mechanism 105 and used by the interchanging drive train system 100 to drive the compressor 103, or the electric motor 102 may be coupled to the interchanging gearbox 104 via the second coupling mechanism 106 and used by the interchanging drive train system 100 to drive the compressor 103, but not both.

An interchange between the gas turbine engine 101 and the electric motor 102 may be initiated manually or automatically. For example, an operator of the interchanging drive train system 100 may determine that an excess of electricity is available for the interchanging drive train system 100 and manually initiate an interchange from the gas turbine engine 101 being used by the interchanging drive train system 100 to drive the compressor 103 to the electric motor 102 being used by the interchanging drive train system 100 to drive the compressor 103, to take advantage of the excess of electricity. Or for example, in some instances, the interchanging drive train system 100, e.g., the controller 110, may be capable of automatically detecting when an excess of electricity is available for the interchanging drive train system 100 and may automatically initiate an interchange from the gas turbine engine 101 being used to drive the compressor 103 to the electric motor 102 being used to drive the compressor 103. However, the interchanging drive train system 100 may automatically initiate an interchange from the gas turbine engine 101 to the electric motor 102 based on any other factors or in response to any other conditions.

The interchanging drive train system 100 may facilitate an interchange between the gas turbine engine 101 and the electric motor 102 in various ways. In some instances, when an interchange between the gas turbine engine 101 and the electric motor 102 is initiated, the controller 110 may cause an output speed of the driver that is not coupled to the interchanging gearbox 104 and not being used by the interchanging drive train system 100 to drive the compressor 103 (also referred to as the disengaged driver) to increase. For example, when an interchange between the gas turbine engine 101 and the electric motor 102 is initiated, the disengaged driver may begin the interchange at rest, e.g., with an output speed of zero, and the controller 110 may cause the output speed of the disengaged driver to increase in preparation for the disengaged driver becoming the driver that is coupled to the interchanging gearbox 104 and being used by the interchanging drive train system 100 to drive the compressor 103 (also referred to as the engaged driver). When causing an output speed of the disengaged driver to increase, the controller 110 may obtain or receive an output speed of the engaged driver, and cause the output speed of the disengaged driver to increase at a first rate until the output speed of the disengaged driver is within a threshold percentage, e.g., 5%, of the output speed of the engaged driver.

When the output speed of the disengaged driver is within the threshold percentage of the output speed of the engaged driver, the controller 110 may cause the output speed of the disengaged driver to increase at a second rate that is greater than the first rate, and may cause the output speed of the engaged driver to decrease. In this way, when the output speed of the disengaged driver nears the output speed of the engaged driver, the interchanging drive train system 100 may equalize the output speed of the disengaged driver and the output speed of the engaged driver quickly, thereby avoiding or minimizing any reduction in power transmitted to the gas compressor during the interchange and avoiding or minimizing the likelihood of the interchange adversely affecting either driver. For example, during an interchange between the gas turbine engine 101 and the electric motor 102, the output speed of the output shaft coupling the interchanging gearbox 104 to the compressor 103 may be held substantially constant. To facilitate a safe and consistent interchange between the gas turbine engine 101 and the electric motor 102, when the controller 110 causes the output speed of the engaged driver to decrease, the controller 110 may cause the output speed of the engaged driver to decease to a predetermined set point that is consistent and stable.

During an interchange between the gas turbine engine 101 and the electric motor 102, via the operative coupling between the first coupling mechanism 105 and the second coupling mechanism 106 (e.g., through the set of gears 107 of the interchanging gearbox 104), when the output speed of the disengaged driver overtakes the output speed of the engaged driver (or in response to the output speed of the disengaged driver overtaking the output speed of the engaged driver), the coupling mechanism capable of engaging with the disengaged driver automatically does so, and the coupling mechanism engaged with the engaged driver automatically disengages. In this way, the disengaged driver becomes the engaged driver, the engaged driver becomes the disengaged driver, and the interchange is complete.

For example, as mentioned above, the first coupling mechanism 105 and the second coupling mechanism 106 may include overrunning clutches. An overrunning clutch may operate in various ways. In one example, an overrunning clutch operatively disposed between an input providing a rotational driving force (e.g., an output shaft of a driver) and a rotating component being rotated by the rotational driving force (e.g., the set of gears 107 of the interchanging gearbox 104) may be configured to automatically disengage and allow the rotating component to rotate independently of the rotational driving force when the rotational speed of the rotating component exceeds the rotational speed of the rotational driving force. Thus, when the output speed of the disengaged driver exceeds or overtakes the output speed of the engaged driver, the coupling mechanism disposed between the engaged driver and the set of gears 107 of the interchanging gearbox 104 may be configured to automatically disengage and allow the set of gears 107 to rotate independently of the now-previously engaged driver, such that the set of gears 107 may then be rotated by the now-previously disengaged driver. At this point, the previously engaged driver becomes the disengaged driver, the previously disengaged driver becomes the engaged driver, and the interchange is complete.

In another example, the first coupling mechanism 105 and the second coupling mechanism 106 may include quill clutches (also referred to as quill drives). A quill clutch may include a hollow outer shaft and a solid inner shaft at least partially encased by the outer shaft. The inner shaft may be configured to move between a first position in which a rotational driving force translated through the inner shaft is not translated through the outer shaft and a second position in which the rotational driving force translated through the inner shaft is translated through the outer shaft. In this example, the inner shaft of a first quill clutch coupled to the disengaged driver is the output shaft of the disengaged driver. When the output speed of the disengaged driver is zero, the inner shaft of the first quill clutch is in the first position. In this example, as the output speed of the disengaged driver increases, the inner shaft of the first quill clutch moves from the first position toward the second position. For example, as the output speed of the disengaged driver increases, the rotational driving force produced by the disengaged driver may cause the inner shaft of the first quill clutch to rotate in a first direction (e.g., clockwise) and to thereby be screwed further into the outer shaft of the first quill clutch, until the inner shaft may be screwed no further into the outer shaft, at which point the inner shaft has reached the second position, in which the rotational driving force translated through the inner shaft may be translated through the outer shaft and further through the set of gears 107 of the interchanging gearbox 104. However, if the outer shaft were to rotate in a second direction opposite the first direction (e.g., counterclockwise), the rotation of the outer shaft would cause the inner shaft to rotate in the second direction and thereby be unscrewed further out of the outer shaft. Unscrewing the inner shaft further out of the outer shaft causes the inner shaft to move from the second position toward the first position. A quill clutch may therefore be considered a type of overrunning clutch.

In this example, the inner and outer shafts of a second quill clutch coupled to the engaged driver operate similarly; however, the output shafts of the two drivers rotate oppositely. Thus, when the inner shaft of the first quill clutch reaches the second position, and when the output speed of the disengaged driver exceeds or overtakes the output speed of the disengaged driver, the set of gears 107 of the interchanging gearbox 104 translate the rotational driving force of the disengaged driver to the outer shaft of the second quill clutch, which causes the inner shaft of the second quill clutch to be unscrewed and thereby move from the second position toward the first position. At this point, the previously engaged driver has been automatically disengaged and is now the disengaged driver, the previously disengaged driver has been automatically engaged and is now the engaged driver, and the interchange is complete. Although the two drivers rotate oppositely, the set of gears 107 of the interchanging gearbox 104 may be configured such that the output shaft of the interchanging gearbox 104 only rotates in a single direction, no matter which direction the output shaft of the engaged driver rotates.

As mentioned above, when facilitating an interchange between the gas turbine engine 101 and the electric motor 102, the interchanging drive train system 100 may cause an output speed of the disengaged driver to increase and/or cause an output speed of the engaged driver to decrease. The controller 110 may cause the output speed of the disengaged driver to increase in various ways, or cause the output speed of the engaged driver to decrease in various ways, depending on what type(s) of driver(s) the disengaged and engaged drivers are. For example, if the disengaged driver is the gas turbine engine 101, the controller 110 may cause the output speed of the gas turbine engine 101 to increase by causing a fuel input or an air input to the gas turbine to be increased. For example, the controller 110 may cause an air input to the gas turbine engine 101 to be increased by opening a bleed valve included in or coupled to the gas turbine engine 101. Conversely, if the engaged driver is the gas turbine engine 101, the controller 110 may cause the output speed of the gas turbine engine 101 to decrease by causing a fuel input or an air input to the gas turbine engine 101 to be decreased. The controller 110 may cause an air input to the gas turbine engine 101 to be decreased by closing a bleed valve included in or coupled to the gas turbine engine 101. Or, for example, if the disengaged driver is the electric motor 102, the controller 110 may cause the output speed of the electric motor 102 to increase by causing an amount of electrical energy provided to the electric motor 102 to be increased. Conversely, if the engaged driver is the electric motor 102, the controller 110 may cause the output speed of the electric motor 102 to decrease by causing an amount of electrical energy provided to the electric motor 102 to be decreased. However, the controller 110 may increase or decrease an output speed of an inactive or engaged driver in any other appropriate way.

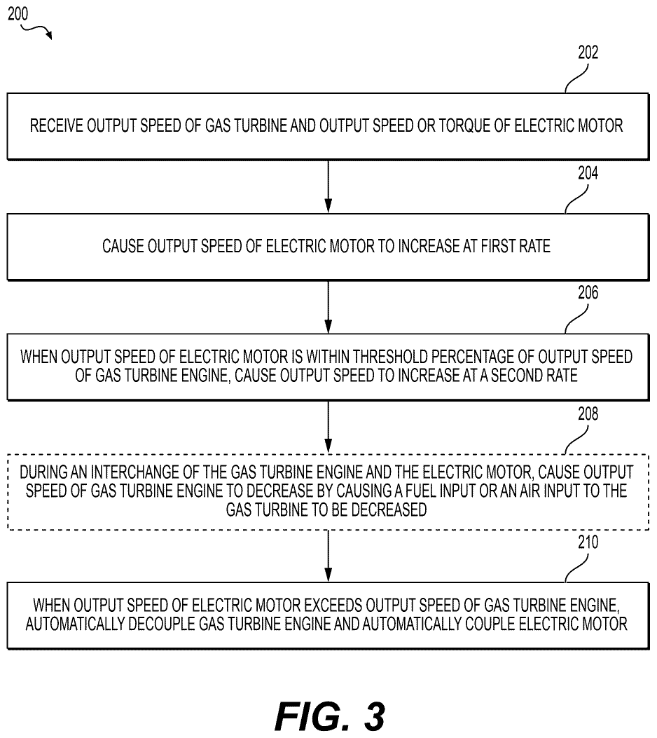

FIG. 3 depicts a flowchart of an exemplary method 200 for controlling an interchanging drive train system 100, which may include a compressor 103, a gas turbine engine 101, an electric motor 102, an interchanging gearbox 104 coupled to the compressor 103, selectively coupled to the gas turbine engine 101, and selectively coupled to the electric motor 102, and a controller 110 coupled to the gas turbine engine 101 and the electric motor 102. Although the steps of the method 200 are shown and described in a particular order, it will be understood that any steps of the method 200 may be performed in any appropriate order, or simultaneously. For simplicity, in the examples described hereinafter, the interchanging drive train system 100 includes a gas turbine engine 101 an electric motor 102 and a compressor 103. However, as mentioned above, it will be understood that the drivers of the interchanging drive train system 100 may include any type of mechanism or device capable of producing mechanical or kinetic energy, and that the load of the interchanging driver trains system 100 may include any mechanism or device capable of being driven or powered by mechanical or kinetic energy.

In some instances, the method 200 begins after an interchange between the gas turbine engine 101 and the electric motor 102 is initiated. As described above, an interchange between the gas turbine engine 101 and the electric motor 102 may be initiated manually or automatically. In the example depicted in FIG. 3, the gas turbine engine 101 begins the interchange as the engaged driver coupled to the interchanging gearbox 104 and being used by the interchanging drive train system 100 to drive the compressor 103, and the electric motor 102 begins the interchange as the disengaged driver decoupled from the interchanging gearbox 104 and not being used by the interchanging drive train system 100 to drive the compressor 103.

In some instances, as depicted in FIG. 3, the method 200 begins with a step 202, in which the controller 110 receives an output speed of the gas turbine engine 101 and an output speed of the electric motor 102. For example, as described above, the controller 110 may receive the output speed of the gas turbine engine 101 via driver output sensor data 114 from a first driver output sensor 108 included in or otherwise coupled to the gas turbine engine 101, and the controller 110 may receive the output speed of the electric motor 102 via driver output sensor data 114 from a second driver output sensor 108 included in or otherwise coupled to the electric motor 102.

In some instances, as depicted in FIG. 3, after the controller 110 receives an output speed of the gas turbine engine 101 and an output speed of the electric motor 102, the method 200 continues with a step 204, in which the controller 110 causes the output speed of the electric motor 102 to increase at a first rate, such as by transmitting a driver control command 115 to the electric motor 102. For example, as described above, the controller 110 may cause the output speed of the electric motor 102 to increase by increasing an amount of electrical energy provided to the electric motor 102 to be increased.

In some instances, as depicted in FIG. 3, when the output speed of the electric motor 102 is within a threshold percentage of the output speed of the gas turbine engine 101, the method 200 continues with a step 206, in which the controller 110 causes the output speed of the electric motor 102 to increase at a second rate that is greater than the first rate, and a step 208, in which the controller 110 causes the output speed of the gas turbine engine 101 to decrease, such as by transmitting one or more driver control commands 115 to the electric motor 102 and the gas turbine engine 101, respectively. For example, as described above, the controller 110 may cause the output speed of the gas turbine engine 101 to decrease by causing a fuel input or an air input to the gas turbine engine 101 to be decreased. The controller 110 may cause an air input to the gas turbine engine 101 to be decreased by closing a bleed valve included in or coupled to the gas turbine engine 101.

In some instances, as depicted in FIG. 3, when the output speed of the electric motor 102 exceeds the output speed of the gas turbine engine 101, the method 200 continues with a step 210, in which the interchanging gearbox 104 automatically decouples from the gas turbine engine 101 and automatically couples to the electric motor 102. For example, the interchanging gearbox 104 may include a first coupling mechanism 105 coupled to the gas turbine engine 101 and a second coupling mechanism 106 capable of coupling to the electric motor 102. The first coupling mechanism 105 and the second coupling mechanism 106 may be overrunning clutches that are mechanically operated and coupled by a set of gears 107 housed within the interchanging gearbox 104. Via the operative coupling between the first coupling mechanism 105 and the second coupling mechanism 106, when the output speed of the electric motor 102 overtakes the output speed of the gas turbine engine 101, the first coupling mechanism 105 automatically decouples from the gas turbine engine 101, and the second coupling mechanism 106 automatically couples to the electric motor 102, and the interchange is complete.

By allowing a compressor 103 to be interchangeably driven by a gas turbine engine 101 and an electric motor 102, the interchanging drive train system 100 provides operators with increased operational and fuel/power flexibility. By arranging the gas turbine engine 101 and the electric motor 102 in parallel, the interchanging drive train system 100 reduces its footprint, facilitates interchange between the gas turbine engine 101 and the electric motor 102, and allows various components of the interchanging drive train system 100 to use shared operational systems, such as a shared lubrication system 109 or a shared air intake system 117. Arranging the gas turbine engine 101 and the electric motor 102 in parallel may also avoid or minimize alignment challenges of drive train systems that include multiple drivers arranged in series.

It will be apparent to those skilled in the art that various modifications and variations can be made to the disclosed method and system without departing from the scope of the disclosure. Other embodiments of the method and system will be apparent to those skilled in the art from consideration of the specification and practice of the apparatus and system disclosed herein. It is intended that the specification and examples be considered as exemplary only, with a true scope of the disclosure being indicated by the following claims and their equivalents.

What is claimed is:

1. An interchanging drive train system for driving a compressor, comprising:
an interchanging gearbox coupled to the compressor;
a gas turbine engine selectively coupled to the interchanging gearbox via a first coupling mechanism; and
an electric motor selectively coupled to the interchanging gearbox via a second coupling mechanism,
wherein the interchanging gearbox is configured to allow the compressor to be interchangeably driven by the gas turbine engine and the electric motor.

2. The interchanging drive train system of claim 1, wherein the first and second coupling mechanisms are housed within the interchanging gearbox.

3. The interchanging drive train system of claim 2, wherein:
the first and second coupling mechanisms are mechanically operated;
the first coupling mechanism is configured to automatically decouple the gas turbine engine from the interchanging gearbox in response to an output speed of the electric motor exceeding an output speed of the gas turbine engine; and
the second coupling mechanism is configured to automatically decouple the electric motor from the interchanging gearbox in response to the output speed of the gas turbine engine exceeding the output speed of the electric motor.

4. The interchanging drive train system of claim 1, wherein:
the compressor is coupled to a first side of the interchanging gearbox; and
the gas turbine engine and the electric motor are arranged in parallel and selectively coupled to a second side of the interchanging gearbox opposite the first side.

5. The interchanging drive train system of claim 1, further comprising a shared lubrication system coupled to the interchanging gearbox, the compressor, the gas turbine engine, and the electric motor.

6. The interchanging drive train system of claim 1, further comprising a shared air intake system coupled to the compressor and the gas turbine engine.

7. The interchanging drive train system of claim 1, further comprising a controller configured to manage one or more aspects of an interchange of the gas turbine engine and the electric motor.

8. The interchanging drive train system of claim 7, further comprising at least one driver output sensor configured to detect an output speed of the gas turbine engine and an output speed of the electric motor and wherein the controller is further configured to manage one or more aspects of the interchange of the gas turbine engine and the electric motor based at least in part on the output speed of the gas turbine engine and the output speed of the electric motor detected by the at least one driver output sensor.

9. The interchanging drive train system of claim 8, wherein, when the gas turbine engine is coupled to the interchanging gearbox via the first coupling mechanism, the controller is further configured to manage one or more aspects of the interchange of the gas turbine engine and the electric motor by:
causing the output speed of the electric motor to increase by a first rate until the output speed of the electric motor is within a threshold percentage of the output speed of the gas turbine engine; and
when the output speed of the electric motor is within the threshold percentage of the output speed of the gas turbine engine, cause the output speed of the gas turbine to decrease and cause the output speed of the electric motor to increase at a second rate that is greater than the first rate.

10. The interchanging drive train system of claim 8, wherein the controller is further configured to cause the output speed of the gas turbine engine to decrease during the interchange of the gas turbine engine and the electric motor by causing a fuel input or an air input to the gas turbine engine to be decreased.

11. A controller for an interchanging drive train system,
the interchanging drive train system comprising:
a gas turbine engine;
an electric motor; and
an interchanging gearbox coupled to a compressor, selectively coupled to the gas turbine engine, and selectively coupled to the electric motor,
wherein the interchanging drive train system is configured to allow the compressor to be interchangeably driven by the gas turbine engine and the electric motor, and
wherein the controller comprises a processor configured to:
receive an output speed of the gas turbine engine and an output speed of the electric motor from at least one driver output sensor coupled to the gas turbine engine and the electric motor; and
manage one or more aspects of an interchange of the gas turbine engine and the electric motor based at least in part on the output speed of the gas turbine engine and the output speed of the electric motor.

12. The controller of claim 11, wherein, when the gas turbine engine is coupled to the interchanging gearbox, the processor is further configured to:
cause the output speed of the electric motor to increase by a first rate until the output speed of the electric motor is within a threshold percentage of the output speed of the gas turbine engine; and
when the output speed of the electric motor is within the threshold percentage of the output speed of the gas turbine engine, cause the output speed of the gas turbine engine to decrease and cause the output speed of the electric motor to increase at a second rate that is greater than the first rate.

13. The controller of claim 11, wherein the processor is further configured to cause the output speed of the gas turbine engine to decrease during the interchange of the gas turbine engine and the electric motor by causing a fuel input to the gas turbine engine to be decreased.

14. The controller of claim 11, wherein the processor is further configured to cause the output speed of the gas turbine engine to be decreased during the interchange of the gas turbine engine and the electric motor by causing an air input to the gas turbine engine to be decreased.

15. The controller of claim 14, wherein the processor is further configured to cause the air input to the gas turbine engine to be decreased by closing a bleed valve coupled to the gas turbine engine.

16. An interchanging drive train system for driving a compressor, comprising:
a gas turbine engine;
an electric motor;
an interchanging gearbox selectively coupled to the gas turbine engine via a first coupling mechanism, selectively coupled to the electric motor via a second coupling mechanism, coupled to the compressor, and configured to allow the compressor to be interchangeably driven by the gas turbine engine and the electric motor; and
a controller configured to manage one or more aspects of an interchange of the gas turbine engine and the electric motor,
wherein the compressor is coupled to a first side of the interchanging gearbox, and
wherein the gas turbine engine and the electric motor are arranged in parallel and coupled to a second side of the interchanging gearbox opposite the first side.

17. The interchanging drive train system of claim 16, further comprising at least one driver output sensor coupled to the gas turbine engine and the electric motor and configured to detect an output speed of the gas turbine engine and an output speed of the electric motor.

18. The interchanging drive train system of claim 17, wherein:
the first and second coupling mechanisms are housed within the interchanging gearbox and mechanically operated;
when the gas turbine engine is coupled to the interchanging gearbox via the first coupling mechanism and when the output speed of the electric motor is within a threshold percentage of the output speed of the gas turbine engine, the controller is further configured to manage one or more aspects of the interchange of the gas turbine engine and the electric motor by decreasing the output speed of the gas turbine engine and increasing the output speed of the electric motor; and
in response to the output speed of the electric motor exceeding the output speed of the gas turbine engine, the first coupling mechanism is configured to automatically decouple the gas turbine engine from the interchanging gearbox and the second coupling mechanism is configured to automatically couple the electric motor to the interchanging gearbox.

19. The interchanging drive train system of claim 16, further comprising a shared lubrication system coupled to the interchanging gearbox, the compressor, the gas turbine engine, and the electric motor.

20. The interchanging drive train system of claim 19, further comprising a shared air intake system coupled to the compressor and the gas turbine engine.
